(19) United States
(12) Patent Application Publication
(10) Pub. No.: US 2007/0118812 A1
(43) Pub. Date: May 24, 2007

(54) Masking for presenting differing display formats for media streams

(75) Inventors: Lawrence Kesteloot, San Francisco, CA (US); Paul Rechsteiner, Toronto (CA); Michael A. Malcolm, Aspen, CO (US)

Correspondence Address: SWERNOFSKY LAW GROUP PC, P.O. BOX 390013, MOUNTAIN VIEW, CA, 94039-0013, US

(73) Assignee: Kaleidescope, Inc., Mountain View, CA (US)

(21) Appl. No.: 10/564,811

(22) PCT Filed: Jul. 14, 2004
(86) PCT No.: PCT/US04/22847

§ 371 Date: Jan. 17, 2006

Related U.S. Application Data
(63) Continuation-in-part of application No. 10/655,496, filed on Sep. 3, 2003.
(60) Provisional application No. 60/488,367, filed on Jul. 15, 2003.

(51) Int. Cl. G06Q 99/00; H04N 11/20

(52) U.S. Cl. 715/800; 348/445; 705/1

(57) ABSTRACT

The invention provides a method and system capable of displaying media streams in a variety of formats on a screen that is dynamically adjustable to conform to displaying the media format that is the object of the media stream. Specifically, the invention allows the viewable area of a display screen (143) to be dynamically resized using masks (161) and sidebars (163), thus the resulting viewable area is optimized for the media stream. A database (110) includes metadata (113) for media presentations. When a user (190) selects a presentation to view, a server (130) associated with the user (190) queries the database (110) for metadata (113) associated with the presentation. The metadata (113) includes aspect ratio and other information for the presentation and sends a response to the server (130) that includes the metadata (113). A portion of the metadata (113) returned to the server (130) is used by a mask controller (160) to appropriately format the display screen (143) on which the user (190) will view the presentation.

### CROSS-REFERENCE TO RELATED APPLICATIONS

This application incorporates by reference and claims priority of U.S. patent application Ser. No. 10/655,496, filed Sep. 3, 2003, which in turn is based on and claims priority of U.S. Provisional Patent Application 60/488,367, filed Jul. 15, 2003, the contents being incorporated herein by reference. The cited provisional application incorporates a technical appendix that includes “Automatic Masking.” (Paul Rechsteiner, Nik Gervae, Shawn Neely, Michael Malcolm, Ray DePaul, Daniel Collens).

### BACKGROUND OF THE INVENTION

1. Field of the Invention

The invention relates to display screen masking for presentation of differing formats of media streams. In aspects thereof, the invention relates to control by a computing device of screen masking in response to information about a media stream to be presented.

2. Related Art

Home theater systems have become very popular due to the high quality that can be attained for a relatively small investment. With the purchase of a large screen television and a surround sound system, a user can get a taste of the movie theatre experience. With the recent reduction in cost of video projectors and consumer desires for a larger more “cineplex” feel, many consumers are moving from big screen televisions to projectors that can produce huge, highly detailed visual presentations; however, this paradigm shift is not without its own set of problems.

A first known problem is that there are distinct aspect ratios for media streams, such as 4×3 (1.33:1) and 16×9 (1.78:1), but the physical screen has only one size. Other common aspect ratios are 1.66:1, 1.85:1, 2.20:1, and 2.35:1; the last three are sometimes called widescreen format. (Some of these aspect ratios are due to use of television, others due to use of screens.)

When an image is for example in 1.85:1 and the screen is 1.33:1 there is a mismatch, and the usual solution is to not use a portion of the screen. When the screen is reflective (such as when a projector is used), this presents a problem because the physical screen is highly reflective, so the part outside the intended media stream displays as an iridescent grey, rather than an unseen black. This diminishes the viewing experience of the viewer.

A first known solution includes velvet masks that can be placed at the top and bottom of the screen to cover the portion that is not being used for display. A second known solution is to letterbox the presentation by adding dark bars at the top and bottom; however, letterboxing doesn't really provide a solution because a TV screen still shows some grayish image.

A second known problem is that it is generally not possible to tell from the media stream itself what the correct aspect ratio should be, thus even when applying the velvet masks solution, manual user adjustment and refinement is required and may not provide the optimal presentation of the media.

A third known problem is that the actual masking used with the media stream might be imperfect and require adjustment, such as at only the top, only the bottom, or both. This is due to some media mastering houses that make errors in transfers of some media from older formats or have to compromise based on an old format or damage to the master media copy. In such cases, an image may be shifted horizontally and/or vertically by a significant number of pixels. In this case velvet masks that have been placed for a first presentation in a first format may obscure part of an image of a second media presentation in the same first format. Manual adjustment is once again an option, but it is an imperfect solution to home theater systems as today's users expect excellence at the touch of a button.

A fourth known problem is that some media streams are permanently reformatted inside an aspect ratio using black bars. This causes the image to be displayed smaller on a display screen with a different aspect ratio. For example, a movie in a ratio of 1.85:1 may have been letterboxed with black bars such that the displayed image including the black bars is now in a ratio of 1.33:1. If a user has a 1.85:1 display screen the image portion of interest to the user is trapped in the black bars.

Accordingly, it would be advantageous to provide a technique for displaying differing formats for media streams that improves on those techniques known in the art.

### SUMMARY OF THE INVENTION

The invention provides a method and system capable of displaying media streams in a variety of formats on a screen whose aspect ratio is dynamically adjustable to conform to displaying the media format that is the object of the media stream. Specifically, the invention allows the viewable area of a display screen to be dynamically resized using masks and sidebars, thus the resulting viewable area is optimized for the media stream.

In a first embodiment, a database includes metadata for media presentations (such as movies). When a user selects a presentation to view, a server associated with the user queries the database for metadata associated with the presentation selected by the user. The metadata includes aspect ratio and other information for the presentation and sends a response to the server that includes the metadata.

The portion of the metadata returned to the server is used by a mask controller to appropriately format the display screen on which the user will view the presentation. This includes horizontal and vertical adjustments to the size of the viewing area.

In a second embodiment of the invention, additional formatting information is included for controlling the size and placement of the display area For example, a combination of horizontal and vertical offset may be included such that even though the presentation is in a ratio of 1.85:1, the image has been moved down 25 pixels. Additional commands may allow for subtitle space and other anomalies and special feature requirements when viewing some presentations. Resizing of the viewing area can occur at anytime before, during, or after a presentation as required.

In a third embodiment, additional information may be included in the metadata that controls other devices such as audio systems and lighting.

In a fourth embodiment, the user may notify the server and/or the database that the metadata provided is inaccurate. This notification can include the settings that the user has found to be optimal. This may also occur when the database did not initially contain associated metadata for the presentation to be viewed by the user, thus the user is able to provide metadata that may be used by others.

In a fifth embodiment, at least some portion of the database is included at the local server such that the local server is periodically updated. Metadata can be customized by the user to meet their personal taste.

In a sixth embodiment, auto-detection of mask placement is accomplished by analyzing the media stream to determine the aspect ratio of the media stream and/or the location of the boundary between the displayed portion of the media stream of interest to the user and the displayed portion of the video stream not of interest to the user or not displayed.

In a seventh embodiment, masking may be accomplished using non-physical masks in the form of “light masking.” Light masking displays bars, similar to the black bars used to letterbox some media streams, but the bars used for light masking are specifically chosen from a set of colors known to provide relatively equal screen burn-in yet remain unobtrusive.

After reading this application, those skilled in the art would recognize that the invention provides an enabling technology by which substantial advance is made in the art of media streams and digital content representative thereof.

Accordingly, it would be advantageous to provide a technique for presenting differing display formats that is not subject to drawbacks of the known art.

### BRIEF DESCRIPTION OF THE DRAWINGS

FIG. 1 shows a block diagram of a system including masking for presenting differing display formats for media streams.

FIG. 2 illustrates mask and sidebar placement and movement in a method including operation of a system including masking for presenting differing formats for media streams.

FIG. 3 shows a process flow diagram of a method including operation of a system including masking for presenting differing formats for media streams.

### DETAILED DESCRIPTION OF THE PREFERRED EMBODIMENT

In the description herein, a preferred embodiment of the invention is described, including preferred process steps and data structures. Those skilled in the art would realize, after perusal of this application, that embodiments of the invention might be implemented using a variety of other techniques not specifically described, without undue experimentation or further invention, and that such other techniques would be within the scope and spirit of the invention.

Definitions

The general meaning of each of these following terms is intended to be illustrative and in no way limiting.
The phrase “media stream” describes information intended for presentation in a sequence, such as motion pictures including a sequence of frames or fields, or such as audio including a sequence of sounds. As used herein, the phrase “media stream” has a broader meaning than the standard meaning for “streaming media,” (of sound and pictures that are transmitted continuously using packets and that start to play before all of the content arrives). Rather, as described herein, there is no particular requirement that “media streams” must be delivered continuously. Also as described herein, media streams can refer to other information for presentation, such as for example animation or sound, as well as to still media, such as for example pictures or illustrations, and also to databases and other collections of information.
The phrase “digital content” describes data in a digital format, intended to represent media streams or other information for presentation to an end viewer. “Digital content” is distinguished from packaging information, such as for example message header information. For the two phrases “digital content” and “media stream,” the former describes a selected encoding of the latter, while the latter describes a result of presenting any encoding thereof.
DVD, or digital versatile disc, is a technology standard that stores data on optical discs. Like the CD (compact disc) that came before it, a DVD holds its information in a digital format as bits denoting ones and zeros on the surface of the disc.
The phrase “digital media,” and the like, describes physical media capable of maintaining digital content in an accessible form. Digital media includes disk drives (including magnetic, optical, or magneto-optical disk drives), as well as any other physical media capable of maintaining information, such as digital content.
The term “bookmark” describes a reference to a logical location selected within a media stream. In one embodiment, bookmarks are not necessarily pre-selected by the creator or distributor of that media stream, and are possibly dynamically selected by a recipient of digital content representing that media stream. In one embodiment, presentation devices are capable of starting or restarting presentation from a selected bookmark.
The term “watchpoint” describes a reference to a logical state of a presentation device, such as for example a logical location selected within a media stream. In one embodiment, watchpoints are capable of associating one or more events therewith, and (preferably) those one or more events might be conditioned on some other data or state information. For one example, the user might designate a bookmark at the beginning of a selected film clip, a watchpoint with the end of that same film clip, and an event associated with the watchpoint, which event directs a presentation device to return to a presentation state it was at before presenting from the bookmark. In this example, the film clip effectively acts as a media element capable of being inserted into another, different, media stream, without involving any other digital content associated with the larger media stream that contains that film clip.
The term “overscan” refers to the part of the video frame (at the edge) not shown by a projector or display. Typically the overscan area is between one percent (1%) and four percent (4%) of image width or height.

The scope and spirit of the invention is not limited to any of these definitions, or to specific examples mentioned therein, but is intended to include the most general concepts embodied by these and other terms.

System Elements

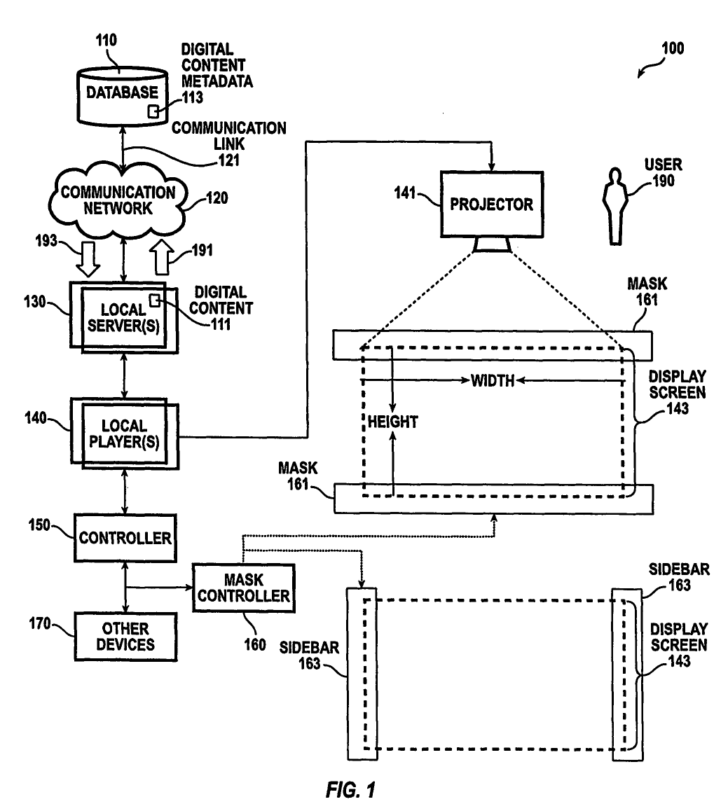

FIG. 1 shows a block diagram of a system including masking for presenting differing display formats for media streams.

A system 100 includes a database 110, a communication network 120, one or more local servers 130, one or more local players 140, a controller 150, a mask controller 160, and other devices 170.

The database 110 includes a set of digital media metadata 113. The digital content metadata 113 includes technically descriptive information concerning digital content 111 useable in a system 100 as further described herein. For example, but without limitation, digital content metadata 113 can include such information as; aspect ratio, surround sound encoding, pixel offset, equalization sound enhancement, available languages, subtitle availability.

In a preferred embodiment, the database 110 is physically remote to a user 190. In the preferred embodiment, the database 110 is under the supervision of an administrator (not shown but understood by one skilled in the art). In an alternative embodiment, at least some portion of the database 110 is physically local to the user 190. In this embodiment, the database 110 may be included with the local servers 130 or local players 140, and the user 190 may exercise at least some control over the database 110.

Digital content 111 includes audio, video, and combinations thereof as used to present sound and images. For example, but without limitation, digital content 111 can include; movies and songs as might be present on digital media such as Compact Discs, DVDs, Digital Audio Tape, and electronic computer storage devices.

The communication network 120 includes at least a portion of a communication network, such as a LAN, a WAN, the Internet, an intranet, an extranet, a virtual private network, a virtual switched network, or some combination thereof. In a preferred embodiment, the communication network 120 includes a packet switched network such as the Internet, as well as (in addition to or instead of) the communication networks just noted, or any other set of communication networks that enable the elements described herein to perform the functions described herein.

A communication link 121 operates to couple the elements of the system 100 such that the elements can communicate between each other as further described herein.

The system 100 includes one or more local servers 130. Each local server 130 includes a processor, a main memory, and software for executing instructions (not shown, but understood by one skilled in the art). This software preferably includes communications and control software capable of operating the local server 130 consistent with the invention as further explained herein.

The system 100 includes one or more local players 140. Each local player 140 includes a device capable of delivering digital content 111 to a presentation device. For example, but without limitation, a local player 140 may include a DVD player, a digital media stream decoder, a laser disc player, or some combination thereof.

A projector 141 includes any device capable of rendering digital content 111 as humanly viewable media. A display screen 143 includes a surface disposed to display an image. Generally the display screen is flat, smooth, and rectangular; however, there is no requirement that any of these properties exist and the only required property of the display screen 143 is that it has some light reflective property.

Two display screens 143 are illustrated in FIG. 1. The display screen 143 illustrated immediately adjacent to the projector 141 depicts a mask 161 at the top and a mask 161 at the bottom of the display screen 143. The second display screen 143 illustrated depicts a sidebar 163 at each side of the display screen 143. In a preferred embodiment of the invention, both masks 161 and sidebars 163 are used simultaneously on a single display screen 143. In alternative embodiments, any combination of masks 161 and sidebars 163 may be used.

The display screen 143 in a system 100 may have practically any dimension. Preferably, the display screen is a rectangle. The unaltered size and horizontal to vertical ratio of the display screen 143 is based on the preference of the user 190 and any physical limitations of the environment that the display screen 143 is in. A first user 190 may prefer an unaltered display screen 143 in a ratio of 4:3 (broadcast television standard). A second user 190 may prefer an unaltered display screen 143 in a 1.78:1 ratio. Regardless of the native size of the display screen 143, the invention may be applied to accommodate viewing of practically any digital content 111.

The controller 150 includes some portion of a computing device capable of interpreting data and issuing commands to a mask controller 160 and other devices 170 responsive to presentation of digital content 111.

The mask controller 160 includes some portion of a computing device capable of interpreting instructions from the controller 150. The mask controller 160 sends commands to move each mask 161 and sidebar 163 to hide or reveal an area of the display screen 143. The mask 161 includes one or more moveable non-reflective surfaces as further described herein. The sidebar 163 includes one or more moveable non-reflective surfaces as further described herein.

Other devices 170 include associative presentation accessories. For example, but without limitation, other devices include; lights, fans, heating and cooling systems, sound systems and combinations thereof. Under the direction of the controller 150, any one of these other devices 170 may be controlled as in integral element of the system 100 as further described herein.

A user 190 includes a human being generally disposed to select and view digital content 111.

Method of Operation

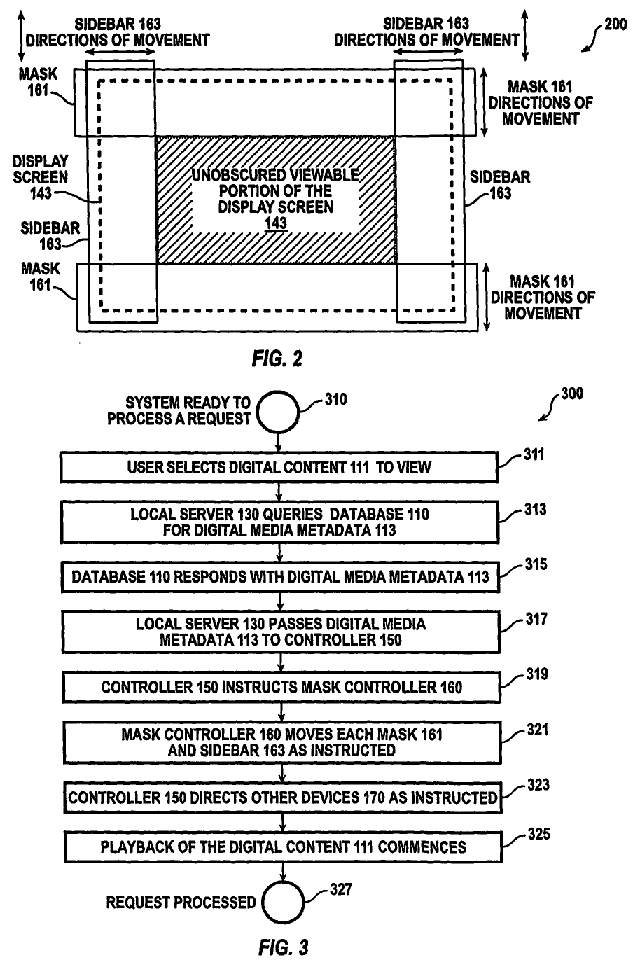

FIG. 2 illustrates mask and sidebar placement and movement in a method including operation of a system including masking for presenting differing formats for media streams.

In a preferred embodiment, each display screen 143 includes two masks 161. The first mask 161 runs horizontally across a top portion of the display screen 143 and is capable of reducing the vertical size of the display screen 143 as it obscures successively more screen area starting at the top edge of the display screen 143. A second mask 161 runs horizontally across a bottom portion of the display screen 143 and is capable of reducing the vertical size of the display screen 143 as it obscures successively more screen area starting at the bottom edge of the display screen 143.

The mask 161 is preferably a non-reflective material (such as, black velvet). The mask 161 may be of a relatively rigid material that moves statically retaining its shape and size or it may be flexible such that it stretches or accordions to different dimensions.

In a preferred embodiment, each display screen 143 includes two sidebars 163. The first sidebar 163 runs vertically across a left portion of the display screen 143 and is capable of reducing the horizontal size of the display screen 143 as it obscures successively more screen area starting at the left most vertical edge of the display screen 143. A second sidebar 163 runs vertically across a right portion of the display screen 143 and is capable of reducing the horizontal size of the display screen 143 as it obscures successively more screen area starting at the right most vertical edge of the display screen 143.

The sidebar 163 is preferably a non-reflective material (such as, black velvet). The sidebar 163 may be of a relatively rigid material that moves statically retaining its shape and size or it may be flexible such that it stretches or accordions to different dimensions as would a curtain. In a preferred embodiment each sidebar 163 is lowered into place from an area above the screen and raised when not needed. In an alternative embodiment, each sidebar 163 is moved in from the side. A combination of the preferred and alternative embodiments may also be used.

Due to the fact that the masks 161 and sidebars 163 do not have to be a rigid and static material, only the leading edge of the mask 161 and/or sidebar 163 would have to move to reveal or obscure an area of the display screen 143. For example, but without limitation, a sidebar 163 that included a velvet curtain could fold and unfold to reveal or obscure an area of the display screen 143. In the preferred embodiment, resizing of the sidebars 163 may be accomplished before, during, or after the sidebars 163 are lowered into place.

Resizing of the display screen 143 may occur in conjunction with bookmarks or watchpoints as defined in the definitions section. The user 190 may, by inserting bookmarks and watchpoints, cause video streams of different aspect ratios to be displayed in rapid succession. In such cases, the digital content metadata 113 associated with subsequent media streams is prefetched and processed appropriately. The user 190 is given some control over the implementation. The user 190 may choose to have the resizing take place just prior to presentation of a new media stream so that all video is viewable (not obstructed by masks 161 and sidebars 163) when the new media stream starts or at some time thereafter. An intelligent mode would compare the aspect ratios of the two media streams and move ahead of the transition of the two media streams only those masks 161 and sidebars 163 that would not interfere with viewing of the current media stream.

For some media presentations, absolute masking may be desirable. The absolute position of each sidebar 163 and mask 161 is specified to the mask controller 160 rather than the aspect ratio of the media stream to be presented. When this is done, overscan must be taken into account. Overscan is the part of the frame (at the edge) that is not displayed by the projector 141 and display screen 143. If the system believes that the top 11% of the frame is black, but the projector 141 clips off the top 3%, then the top mask 161 needs to be brought down less than 11%. The same is true for the sidebars 163. Overscan for the system 100 is calibrated manually using standard video test patterns.

Some mask controllers 160 specify a mask's 161 absolute position in “points” and others in units of time. For example, fully closing the masks 161 may take 10 seconds, or may be specified as 100 points. Fully opening the masks may take 0 seconds (from fully open), or be specified as 0 points. In an embodiment of the invention, the local server 130 can communicate to the mask controller 160 the position of the masks 161 in units that the mask controller 160 can understand natively, such as points, time, or other unit of absolute position. In a calibration step the client device 130 is given two or more absolute locations on the screen 143 (using an on-screen calibration utility), each paired with a value that the mask controller 160 can recognize. For each desired location of a mask 161, the client device 130 can linearly interpolate to generate a value that can be used directly. In a preferred embodiment, three points are calibrated and a quadratic curve is used. Other curves could be used, such as linear, cubic, or exponential. A different curve can be used for top, bottom, and each side mask 161, and potentially for any other scenario, such as when changing video modes of a projector 141.

In FIG. 2, the “DIRECTIONS OF MOVEMENT” labels indicate the preferred plane of movement for the masks 161 and sidebars 163. In a preferred embodiment, the leading edges of the masks 161 and sidebars 163 would be horizontal and perpendicular respectively to the display screen 143. In an alternative embodiment, digital content metadata 113 could produce non-horizontally aligned masks 161 and non-vertically aligned sidebars 163 yielding a trapezoidal viewing area of the display screen 143.

Some digital content 111, such as movies, requires an aspect ratio that is not directly related to digital content 111. This occurs, for example, when a foreign film is offered with subtitles. Filmmakers have historically placed the subtitles over the moving images towards the bottom in an effort to make them less obtrusive but readable. With the popularity of widescreen presentations, it is common for filmmakers to place subtitles in the black bar area below the moving images. This allows for easier reading of the text and the text does not obscure or interfere with the moving picture portion.

A problem associated with placing the subtitles in the black bar portion is that if masks 161 and sidebars 163 are placed at the boundaries of the moving picture portion of the digital content 111, the subtitles that are contained in the black bar portion are projected onto the lower mask 161 and not the display screen 143 making them hard or impossible to read. The invention ensures that digital content metadata 113 for every presentation and permutation thereof is available so that masks 161 and sidebars 163 are positioned correctly to allow for subtitles and other idiosyncrasies (for example, icons, ticker symbols, picture in picture portions and combinations thereof).

In an embodiment of the invention, resizing of the digital image and the viewable area of the display screen 143 may be desirable. For example, filmmakers often letterbox a widescreen presentation of a movie by adding black bars at the top and bottom of the movie essentially reformatting the media stream into another aspect ratio, such as 1.33:1 (also known as standard 4:3 television).

In such a case it could be desirable to expand the visual image such that the portion the user 190 is interested in viewing is as large as possible. It will not matter if the black bars are projected on an area outside of the display screen 143 or on a mask 161 or sidebar 163 as the user does not wish to see them anyway. Digital content metadata 113 for positioning the masks 161 and sidebars 163 for media streams formatted in this manner is available in the database 110. The user can determine prior to viewing any digital content 111 whether they want the media stream optimized in this manner or not.

The system provides an onscreen display (OSD) to assist the user 190 in using the system. Whenever the user 190 executes a function, the OSD is activated to display helpful and needed information to the user 190. Generally, it is important that the OSD not interfere with the video presentation. Since the masks 161 and sidebars 163 will usually be at the edge of the video presentation, it is important for the system to take appropriate action to accommodate any OSD. Positional information for the masks 161 and sidebars 163 is maintained and used to calculate new positions for the masks 161 and sidebars 163, thus they can be temporarily moved to accommodate an OSD when it is important that the video presentation not be obscured in any way.

A debugging mode for setting up the system 100 utilizes the OSD for providing guidance to a technician. The OSD debugging mode displays positioning information for the masks 161 and sidebars 163. In a preferred embodiment, the OSD generates a picture frame at a selected aspect ratio, and the technician manually moves the masks 161 and sidebars 163 into place so as to meet the edges of the picture frame. This creates a calibration for the system including a set of values that is stored and ensures that all subsequent video presentations will have masks 161 and sidebars 163 at the optimum positions for a calibrated aspect ratio.

In an embodiment of the invention, auto-detection of mask placement is accomplished. This includes analyzing the media stream to determine the aspect ratio of the media stream and/or the location of the boundary between the displayed portion of the media stream of interest to the user and the displayed portion of the video stream not of interest to the user or not displayed. If auto-detection is successful, digital content metadata 113 can be updated in the database 110, so that auto-detection will not thereafter be necessary. The system 100 may request input from the user 190 to confirm that auto-detection was accurate or to provide additional manual adjustment of masks 161 and sidebars 163.

In an embodiment of the invention, masking may be accomplished using non-physical masks in the form of “light-masking.” Light-masking can provide nonphysical equivalents of masks 161 and sidebars 163. Preferably, colors are chosen than are the least intrusive to the viewing experience of the user yet provide equal burn-in when displayed in conjunction with a media stream.

Light-masking can be applied in conjunction with physical masking such that burn-in of the display is eliminated and the light-masked area is obscured by the physical masks 161 and sidebars 163. Thus, the user 190 benefits by protecting their display device from burn-in and is not distracted by the light-masking as the physical masks 161 and sidebars 163 are in place.

In alternative embodiments, the picture frame may be replaced with a test pattern or any full-framed image with crisply, contrasted edges.

FIG. 3 shows a process flow diagram of a method including operation of a system including masking for presenting differing formats for media streams.

A method 300 includes a set of flow points and steps. Although described serially, these flow points and steps of the method 300 can be performed by separate elements in conjunction or in parallel, whether asynchronously or synchronously, in a pipelined manner, or otherwise. There is no particular requirement that the flow points or steps must be performed in the same order as described, except where explicitly so indicated.

At a flow point 310, the system 100 is ready to process a request from a user 190.

At a step 311, the user 190 makes a selection from available digital content 111 contained on the local servers 130. The user 190 preferably makes their selection by viewing a list on the display screen 143. Alternatively, the user 190 may make their selection at a local player 140 or local server 130.

At a step 313, the local server 130 sends a request 191 to query the database 110 for the digital content metadata 113 associated with the digital content 11 selected by the user 190. In an embodiment of the invention, the user 190 pays a fee for the information retrieved from the database 110. The local server 130 provides identification of the user 190, and the database 10 maintains a transaction history for the user 190 so they can be billed at regular intervals. DVD media are identified by their DVD hash values.

At a step 315, the database 110 locates the digital media metadata 113 associated with the digital content 111 and sends a response 193 back to the local servers 130 that includes the digital media metadata 113.

At a step 317, the local server 130 processes the response 193 by passing identified information to the controller 150. This may include parsing the response 193 into sub-messages for individual processing by elements of the system 100. For example, but without limitation, parsing may extract data to be used by the mask controller 160 and data to be used by the controller 150 to instruct the other devices 170.

At a step 319, the controller identifies the portions of the response 193 that relate to the mask controller 160.

At a step 321, the mask controller 160 interprets the information it has received and issues commands to each mask 161 and sidebar 163 to move to a designated position per the response 193. These actions would preferably take place prior to the start of the presentation of the digital content 111 and would be updated during the presentation of the digital content 111 as designated in the response 193. Some directors have been known to start a movie in one aspect ratio and then move to another.

Currently, about six popular display ratios exist; however, it is within the scope and spirit of the invention to provide for yet unknown display ratios. As described herein, digital content metadata 113 provides the parameter values applied to mask 161 and sidebar 163 placements. Practically any vertical to horizontal ratio display screen 143 can be generated with the associated digital content metadata 113.

At a step 323, the controller 150 directs the other devices 170 consistent with the response 193. For example, but without limitation, the response could include the following instructions; 1) Dim house lights to 5%, 2) Set cooling fans to low/quiet speed, 3) Set surround system to 6.1 compliant, and 4) set DPS mode for audio system to rock concert preset. Some users 190 would have the other devices 170 and some would not. For those users 190 who do not have other devices 170 to control, any control messages for such would be ignored.

At a step 325, playback of the digital content 111 commences.

At a flow point 327, the system 100 has processed at least one request.

### Alternative Embodiments

Although preferred embodiments are disclosed herein, many variations are possible which remain within the concept and scope of the invention. These variations would become clear to those skilled in the art after perusal of this application.
The invention is not restricted to presentation of movies, but is also applicable to other media streams, such as for example animation, as well as to still media, such as for example pictures or illustrations, and to presentation of databases and other collections of information, or of user interfaces associated with operating systems or application software.
The invention is not restricted to projection screens and physical masks, but is equally applicable to masking applications on other types of displays, such as for example plasma displays, where specifying the aspect ratio, frame size, and active video size can produce blanking of an inactive region of the display. This could be used to reduce screen burn-in.
An embodiment of the invention would use an electronic equivalent of a combination of masks 161 and sidebars 163. Placement of masks 161 and sidebars 163 would still be determined and implemented as in the preferred embodiment with the exception that instead of physical masks 161 and sidebars 163, electronic versions would be used (such as the previously mentioned display of a color that would reduce burn-in)

Those skilled in the art will recognize, after perusal of this application, that these alternative embodiments are illustrative and in no way limiting.

1. A method, including steps of adjusting an aspect ratio of a display screen in response to a remote database, the database including information associating aspect ratio information with media streams.

2. A method as in claim 1, wherein said aspect ratio is further adjusted in response to an on-screen display, said on-screen display indicating placement for some combination of masks and sidebars.

3. A method as in claim 1, including steps of
adjusting the aspect ratio in response to input from a viewer; and
sending the adjusted aspect ratio to the database.

4. A method as in claim 1, wherein the information associating aspect ratio information includes
a preselected aspect ratio; and
an adjustment from a known aspect ratio.

5. A method as in claim 1, wherein the steps of adjusting include automatically controlling one or more masks.

6. A method, including steps of
presenting a media stream having a first aspect ratio R1 using a display screen having a second aspect ratio R2;
receiving information from a source external to the media stream, that information relating to R1; and
adjusting R2 in response to that information.

7. A method as in claim 6, wherein the steps of adjusting R2 include automatically moving masking.

8. A method as in claim 6, including steps of contracting the display screen when the media stream includes a picture having a third aspect ratio R3, with R3<R1.

9. A method as in claim 6, including steps of expanding the display screen when the media stream includes a picture having a third aspect ratio R3, with R3>R1.

10. A method, including steps of
recognizing a media stream with a first aspect ratio and user-interested viewable portion R embedded in a media stream having a second aspect ratio S, where S>R, whereby presentation of the media stream can be expanded to a relatively larger region of a display screen; and
presenting the media stream in that relatively larger region.

11. A method as in claim 10, wherein a technique for embedding the first aspect ratio R includes letterboxing.

12. A method as in claim 10, wherein the first aspect ratio R is a known television standard.

13. A method as in claim 10, wherein the second aspect ratio S is a known movie standard.

14. A method, including steps of
recognizing an element to be presented within a media stream; and
adjusting a target location for said element in response to an aspect ratio of that media stream.

15. A method as in claim 14, wherein those steps of adjusting include
adjusting masking of the display screen in response to said element and the media stream; and
positioning the element in an effective display region not blocked by masking.

16. A method as in claim 14, wherein said steps of adjusting include
adjusting the aspect ratio in response to said element and the media stream; and
positioning the element in an effective display region not blocking any substantial portion of the media stream.

17. A method as in claim 14, wherein said steps of adjusting include positioning the target location in an effective display region not blocked by masking.

18. A method as in claim 14, wherein said steps of adjusting include positioning the target location in an effective display region not blocking any substantial portion of the media stream.

19. A method as in claim 14, wherein that element includes at least one of: a caption, a closed-caption, a subtitle, a translation, a ticker feed.

20. A method as in claim 1, wherein said steps of adjusting are responsive to a correlation between values in said database and DVD hash values.

21. A method, including steps of
positioning some combination of masks and sidebars without regard for the aspect ratio of the media presentation, said positioning using absolute positional data values.

22. A method as in claim 21, wherein said steps of positioning include compensation for projector overscan.

23. A method for adjusting the aspect ratio of a display including steps of
identifying a media stream to be presented;
querying a database for metadata associated with said media stream;
parsing said metadata, said steps of parsing yielding one or more informational components;
interpreting at least one of said informational components; and
moving one or more display masks in response to said steps of interpreting, said display masks being capable of obscuring and revealing some portion of said display.

24. A method of claim 23, wherein said display masks include one or more physical objects.

25. A method of claim 23, wherein said display mask includes an area of displayed light, said light of at least one hue determined to reduce screen burn-in at a transition boundary between an adjacently displayed image stream.

26. A method as in claim 23, wherein said steps of identifying include reading at least one DVD hash value, whereby a particular media stream is identified by computing said hash value as a part of said media stream and using said hash value as a key for said first database.

27. A method as in claim 23, wherein
said steps of identifying include interpreting said metadata before beginning presentation of said media stream at a bookmark; and
said steps of moving include moving said display masks before beginning presentation of said media stream at a bookmark.

28. A method as in claim 23, wherein
said steps of identifying include interpreting said metadata in response to watchpoints in said media streams; and
said steps of moving are performed in response to decisions made at those watchpoints.

29. A method as in claim 23, wherein said metadata includes some combination of: an aspect ratio, audio encoding specification, other device control information.

30. Apparatus including
a database including information associating aspect ratio information with media streams;
memory or mass storage capable of receiving that information in response to one of those media streams; and
a masking controller capable of adjusting an aspect ratio of a display screen in response to information in that memory or mass storage.

31. The apparatus of claim 30, wherein said aspect ratio information is adjusted by an input from a viewer.

32. The apparatus of claim 30, wherein the information associating aspect ratio information includes
a pre-selected aspect ratio; and
an adjustment from a known aspect ratio.

33. The apparatus of claim 30, wherein said steps of adjusting include automatically controlling the position of one or more masks or sidebars.

34. A method of doing business, including steps of
providing access to information associating aspect ratio information with media streams; and
collecting a fee in response to those steps of providing access.

35. A method of claim 34, wherein said information associating aspect ratio information with media streams includes data for controlling some combination of a set of masks and a set of sidebars, said set of masks and set of sidebars adjusting the aspect ratio of the viewable portion of a display screen.

36. A physical medium including information readable by a computing device, the information including
a first media stream having a first aspect ratio R1, having been produced in response to a second media stream having a second aspect ratio R2, wherein
R1>R2;
the first media stream is relatively larger than the second media stream; and
the first media stream does not include letterboxing.

37. A method, including steps of adjusting the active area of a display in response to a remote first database, said first database including information associating media streams with some combination of aspect ratio information, horizontal size information, vertical size information, resolution, anamorphic compression, and letterboxing.

38. A method as in claim 37, wherein said active area of said display is a reflective portion of said display visible to the human viewer.

39. A method as in claim 37, wherein said active area of said display is an illuminated portion of said display visible to a human viewer.

40. A method as in claim 37, wherein said active area may be further adjusted in response to an onscreen display, said on-screen display indicating placement for some combination of masks and sidebars.

41. A method as in claim 37, wherein said information in said first database indicates a portion of a video frame occupied by a desired picture, wherein an active area of the display is adjusted to present the desired picture and exclude a remainder of the video frame.

42. A method as in claim 37, wherein said information in said first database indicates a portion of a video frame occupied by a desired picture, whereby the active area of the display is adjusted by enlarging a projected image of said desired picture such that the active area contains the desired picture while excluding at least some portion of the video frame.

43. A method as in claim 42, wherein said information in said first database indicates that at least one video frame is letterboxed.

44. A method as in claim 37, including steps of identifying a particular media stream by computing a hash of a part of the media stream and using said hash as a key with said first database.

45. A method as in claim 37, wherein said steps of adjusting are also responsive to a logically local second database.

46. A method as in claim 45, wherein said second database includes information associating potentially active areas of said display with information in said first database.

47. A method as in claim 45, wherein said second database includes information associating potentially active areas of said display with at least one media stream, said information originally obtained dynamically during playback of said at least one media stream.

48. A method as in claim 45, wherein said second database includes information related to projector overscan.

49. A method as in claim 45, wherein information in said second database may be further adjusted in response to an on-screen display and input from a human viewer.

50. A method as in claim 49, wherein said on-screen display indicates placement for some combination of masks and sidebars.

51. A method, including steps of selecting a target location on a display for each of a first and a second element of a video stream in response to a remote first database, said first database including information associating each of the first and the second element of the media stream with some independent combination of aspect ratio, horizontal size, vertical size, resolution, anamorphic compression, and letterboxing.

52. A method as in claim 51, including steps of adjusting an active area of said display in response to said target locations.

53. A method as in claim 52, wherein said active area is adjusted using some combination of masks and sidebars.

54. A method as in claim 52, wherein said first element includes a motion picture and said second element includes some combination of a caption, a closed-caption, a subtitle, a translation, a ticker feed.

55. A method as in claim 37, wherein said steps of adjusting are responsive to a portion of the media stream being viewed.

56. A method as in claim 37, wherein said steps of adjusting are responsive to the triggering of one or more watchpoints.

57. A method for adjusting the aspect ratio of a display, the method including steps of
determining, from a media stream to be presented, the aspect ratio of said media stream;
calculating at least one informational component in response to said steps of determining;
moving one or more display masks in response to said steps of calculating, said display masks being capable of obscuring and revealing some portion of said display.

58. Apparatus as in claim 30, wherein said database includes information associating, with at least one media stream, some combination of at least one of aspect ratio information, horizontal size information, vertical size information, resolution, anamorphic compression, and letterboxing.

59. The apparatus of claim 58, wherein said controller instructs movement of some combination of masks and sidebars, said masks and sidebars being capable of adjusting the active area of a display screen.

60. A method of doing business as in claim 34, wherein the steps of providing access include providing access to a database, the database including at least some information associating, with at least one media stream, some combination of at least one of aspect ratio information, horizontal size information, vertical size information, resolution, anamorphic compression, and letterboxing.

61. A method as in claim 60, wherein said information includes data for controlling some combination of masks and sidebars, said masks and sidebars being capable of adjusting the active area of a display screen.

62. A method as in claim 1, wherein said steps of adjusting include blanking an inactive area of said display with a color that minimizes burn-in when displayed.

63. A method, including steps of
automatically determining an aspect ratio of a media stream; and
adjusting an aspect ratio of a display screen in response to said steps of automatically determining.

64. Apparatus including
means for adjusting an aspect ratio of a display screen in response to a remote database, the database including information associating aspect ratio information with media streams.

65. Apparatus as in claim 64, wherein said aspect ratio is further adjusted in response to an on-screen display, said on-screen display indicating placement for some combination of masks and sidebars.

66. Apparatus as in claim 64, including
means for adjusting the aspect ratio in response to an input from a viewer; and
means for sending that input to the database.

67. Apparatus as in claim 64, wherein the information associating aspect ratio information includes
a preselected aspect ratio; and
an adjustment from a known aspect ratio.

68. Apparatus as in claim 64, wherein said means for adjusting includes automatically controlling one or more masks.

69. Apparatus, including
means for presenting a media stream having a first aspect ratio R1 using a display screen having a second aspect ratio R2;
means for receiving information from a source external to the media stream, that information relating to R1; and
means for adjusting R2 in response to that information.

70. Apparatus as in claim 69, wherein said means for adjusting R2 includes automatically moving masking.

71. Apparatus as in claim 69, including means for contracting the display screen when the media stream includes a picture having a third aspect ratio R3, with R3<R1.

72. Apparatus as in claim 69, including means for expanding the display screen when the media stream includes a picture having a third aspect ratio R3, with R3>R1.

73. Apparatus, including
means for recognizing a media stream with a first aspect ratio R and user-interested viewable portion embedded in that media stream having a aspect ratio S not equal to R, whereby presentation of the media stream can be expanded to a relatively larger region of a display screen; and
means for presenting the media stream in that relatively larger region.

74. Apparatus as in claim 73, wherein the means for presenting includes letterboxing.

75. Apparatus as in claim 73, wherein the first aspect ratio R includes a known television standard.

76. Apparatus as in claim 73, wherein the second aspect ratio S includes a known movie standard.

77. Apparatus, including
means for recognizing a first element to be presented within a media stream, said element having a different aspect ratio from a second element in said media stream; and
means for adjusting a target location for said first element, in response to an aspect ratio of that second element.

78. Apparatus as in claim 77, wherein said means for adjusting includes
means for adjusting masking of a display screen in response to said first element and said second element; and
means for positioning the first element in an effective display region not blocked by masking.

79. Apparatus as in claim 77, wherein said means for adjusting includes
means for adjusting masking of the display screen in response to said first element and said second element; and
means for positioning the first element in an effective display region not overlapping any substantial portion of the second element.

80. Apparatus as in claim 77, wherein said means for adjusting includes means for positioning the target location in an effective display region not blocked by masking.

81. Apparatus as in claim 77, wherein said means for adjusting includes means for positioning the target location in an effective display region not overlapping any substantial portion of the media stream.

82. Apparatus as in claim 77, wherein that element includes at least one of: a caption, a closed-caption, a subtitle, a translation, a ticker feed.

83. Apparatus as in claim 64, wherein said means for adjusting is responsive to a correlation between values in said database and DVD hash values.

84. Apparatus, including
means for automatically positioning some combination of masks and sidebars associated with a media presentation display screen, without substantial regard for the aspect ratio of the media presentation, said positioning using substantially absolute positional data values associated with said media presentation.

85. Apparatus as in claim 84, wherein said means for positioning includes compensation for projector overscan.

86. Apparatus for adjusting the aspect ratio of a display including
means for identifying a media stream to be presented;
means for querying a database for metadata associated with said media stream;
means for parsing said metadata, said parsing yielding one or more informational components;
means for interpreting at least one of said informational components; and
means for moving one or more display masks in response to said interpreting, said display masks being capable of obscuring and revealing some portion of said display.

87. Apparatus as in claim 86, wherein said means for identifying includes reading at least one DVD hash value, whereby a particular media stream is identified by computing said hash value as a part of said media stream and using said hash value as a key for said first database.

88. A method as in claim 23, wherein
said means for identifying include means for interpreting said metadata in response to watchpoints in said media streams; and
said means for moving are performed in response to decisions made at those watchpoints.

89. Apparatus as in claim 86, wherein said means for identifying includes identifying media streams at watchpoints.

90. Apparatus of claim 86, wherein said metadata includes some combination of: an aspect ratio, audio encoding specification, other device control information.

91. Apparatus including means for adjusting the active area of a display in response to a remote first database, said first database including information associating media streams with some combination of aspect ratio information, horizontal size information, vertical size information, resolution, anamorphic compression, and letterboxing.

92. Apparatus as in claim 91, wherein said active area of said display is a reflective portion of said display visible to the human viewer.

93. Apparatus as in claim 91, wherein said active area of said display is an illuminated portion of said display visible to a human viewer.

94. Apparatus as in claim 91, wherein said active area may be further adjusted in response to an onscreen display, said on-screen display indicating placement for some combination of masks and sidebars.

95. Apparatus as in claim 91, wherein said information in said first database indicates a portion of a video frame occupied by a desired picture, wherein an active area of the display is adjusted to present the desired picture and exclude a remainder of the video frame.

96. Apparatus as in claim 91, wherein said information in said first database indicates a portion of a video frame occupied by a desired picture, whereby the active area of the display is adjusted by enlarging a projected image of said desired picture such that the active area contains the desired picture while excluding at least some portion of the video frame.

97. Apparatus as in claim 96, wherein said information in said first database indicates that at least one video frame is letterboxed.

98. Apparatus as in claim 91 including means for identifying a particular media stream by computing a hash of a part of the media stream and using said hash as a key with said first database.

99. Apparatus as in claim 91, wherein said means for adjusting are also responsive to a logically local second database.

100. Apparatus as in claim 99, wherein said second database includes information associating potentially active areas of said display with information in said first database.

101. Apparatus as in claim 99, wherein said second database includes information associating potentially active areas of said display with at least one media stream, said information originally obtained dynamically during playback of said at least one media stream.

102. Apparatus as in claim 99, wherein said second database includes information related to projector overscan.

103. Apparatus as in claim 99, wherein information in said second database may be further adjusted in response to an on-screen display and input from a human viewer.

104. Apparatus as in claim 103, wherein said on-screen display indicates placement for some combination of masks and sidebars.

105. Apparatus, including means for selecting a target location on a display for each of a first and a second element of a video stream in response to a remote first database, said first database including information associating each of the first and the second element of the media stream with some independent combination of aspect ratio, horizontal size, vertical size, resolution, anamorphic compression, and letterboxing.

106. Apparatus as in claim 105, including means for adjusting an active area of said display in response to said target location.

107. Apparatus as in claim 106, wherein said active area is adjusted using some combination of masks and sidebars.

108. Apparatus as in claim 105, wherein said second element includes a motion picture and said first element includes some combination of a caption, a closed-caption, a subtitle, a translation, a ticker feed.

109. Apparatus as in claim 91, wherein said means for adjusting are also responsive to at least a portion of the media stream being viewed.

110. Apparatus as in claim 91, wherein said means for adjusting are also responsive to triggering of one or more watchpoints.

111. Apparatus as in claim 64, said means for adjusting including means for blanking an inactive area of said display with a color that minimizes burn-in when displayed.

112. Apparatus including
means for automatically determining an aspect ratio of a media stream; and
means for adjusting an aspect ratio of a display screen in response to said means for automatically determining.

113. A physical medium including information readable by a computing device, the information signal incorporating a set of metadata associated with a media stream.

114. A physical medium as in claim 113, wherein the metadata includes instructions interpretable by a viewer device.

115. A physical medium as in claim 114, wherein the viewer device includes at least one of the following: a mask controller, one or more lights, one or more fans, one or more audio systems, one or more heating systems, one or more cooling systems.

116. A physical medium as in claim 113, wherein the metadata is updateable.

117. A physical medium as in claim 116, wherein the update is responsive to one or more user inputs.

118. A physical medium as in claim 113, wherein the metadata is generated, at least in part, in response to the media stream.

119. A physical medium as in claim 118, wherein the metadata includes at least one aspect ratio associated with the media stream.

120. A physical medium as in claim 113, including
information describing a request identifying the media stream;
wherein the metadata includes at least one aspect ratio associated with the media stream.

121. An information signal as in claim 113, including
information describing a response including at least some of the metdata;
wherein the metadata includes at least one aspect ratio associated with the media stream.

122. A physical medium including information readable by a computing device, the information including
a set of displayable reference rectangles;
the rectangles each predisposed to an aspect ratio; and
the aspect ratio being selectable by an operator.

123. A physical medium including information readable by a computing device, the information signal including
one or more mask values, having been produced in response to the manual positioning of one or more masks;
one or more sidebar values, having been produced in response to the manual positioning of one or more sidebars; and
a combination of said mask values and said sidebar values generating an aspect ratio.

124. Apparatus including
means for generating positional data for a set of masks and sidebars, said means for generating responsive to manual positioning of said set of masks and sidebars by an operator;
means for calculating an aspect ratio from said positional data; and
means for storing said positional data in a database.

125. Apparatus including
means for generating a request, said request indicating a media stream;
means for transmitting said request from a first server to a second server; and
means for identifying at least one media stream and at least one set of metadata associated with said request, said metadata including at least one set of aspect ratio information.

126. Apparatus as in claim 125, including
means for generating a response in answer to said request, said response including at least one set of aspect ratio information;
means for transmitting said response from said second server to said first server;
means for parsing said response, said parsing extracting said at least one set of aspect ratio information from said response;
means for interpreting said aspect ratio information at a mask controller; and
means for moving a set of masks responsive to said interpreting.

127. Apparatus including
means for analyzing a media stream, said analyzing generating positional data indicating a user-interested viewable portion and a user-uninterested viewable portion; and
means for placement of a set of masks responsive to said positional data, said placement obscuring said user-uninterested viewable portion.

128. A method as in claim 29, wherein a portion of said metadata is used to control one or more lights.

129. A method as in claim 29, wherein a portion of said metadata is used to control one or more cooling systems.

130. A method as in claim 29, wherein a portion of said metadata is used to control one or more audio systems.

131. Apparatus as in claim 90, wherein a portion of said metadata is used to control one or more lights.

132. Apparatus as in claim 90, wherein a portion of said metadata is used to control one or more cooling systems.

133. Apparatus as in claim 90, wherein a portion of said metadata is used to control one or more audio systems.

134. A method as in claim 6, including steps of maximizing usage of the display screen in response to presence in the media stream of a picture having an aspect ratio R3, with R3 not equal to R1.

135. A method as in claim 10, including steps of sending information describing that relatively larger region to the database.

136. A method, including steps of
recognizing a media stream with a first aspect ratio and user-interested viewable portion R embedded in a media stream having a second aspect ratio S not equal to R, whereby presentation of the media stream can be expanded to a relatively larger region of a display screen; and
presenting the media stream in that relatively larger region.

137. A method as in claim 136, including steps of sending information describing that relatively larger region to the database.

138. A method, including steps of
recognizing an element to be presented within a media stream, said element having a different aspect ratio from said media steam; and
adjusting a target location for said element in response to an aspect ratio of that media stream.

139. A method as in claim 138, including steps of sending information describing that adjusted target location to the database.

140. A method as in claim 21, including steps of determining those absolute positional data values in response to a remote database.

141. A method as in claim 28, including steps of prefetching said metadata before making decisions at those watchpoints.

142. A method as in claim 28, including steps of predicting results of decisions at those watchpoints.

143. Apparatus as in claim 30, including
a communication channel coupled to that masking controller and to that database, and capable of sending information describing that adjusted aspect ratio to the database.

144. Apparatus as in claim 69, including means for maximizing usage of the display screen in response to presence in the media stream of a picture having an aspect ratio R3, with R3 not equal to R1.

145. Apparatus as in claim 84, including means for determining said values in response to a remote database.

146. A method as in claim 88, including steps of prefetching said metadata before making decisions at those watchpoints.

147. A method as in claim 88, including steps of predicting results of decisions at those watchpoints.
